(19) United States
(12) Patent Application Publication
(10) Pub. No.: US 2007/0188875 A1
(43) Pub. Date: Aug. 16, 2007

(54) Refractive lens array for scanner application that reduces lateral tolerance sensitivity

(76) Inventors: Russell W. Gruhlke, Fort Collins, CO (US); Wen-Liang Gao, Eugene, OR (US); John Doherty, Dublin (IE)

Correspondence Address: AGILENT TECHNOLOGIES, INC.;Legal Department, DL429, Intellectual Property Administration, P. O. Box 7599, Loveland, CO, 80537-0599, US

(21) Appl. No.: 11/350,849

(22) Filed: Feb. 10, 2006

(51) Int. Cl. G02B 3/00

(52) U.S. Cl. 359/642

(57) ABSTRACT

A low cost single lens array for use in an automatic optical inspection system, so as to reduce parallax, cross talk, and sensitivity to lateral fabrication errors, and a method for stitching together image segments formed by the array. The lens array comprises a plurality of tube-like baffles, within which are disposed single lens sets and linear image sensors. These baffles are typically arranged to provide de-magnified and inverted image segments that are stitched together to provide the entire image of the surface object.

### BACKGROUND OF THE INVENTION

### 1. Description of the Related Art

Automatic optical inspection systems enable the efficient and cost effective monitoring of printed circuit boards during manufacture. Large circuit board formats and high throughput common in today's low cost manufacturing environment suggest the use of optical line scan systems. Good imaging over large fields is crucial for the operation of such line scan systems.

The use of linear sensor arrays such as contact image sensors (CIS) is known in the technically different fields of flatbed scanners and photocopiers. Here the surface being inspected is flat such as a piece of paper or photograph, not a printed circuit board, which has components of varying heights. Furthermore, current CIS imaging systems are designed for working at very close distances from the target surface. This is in contrast to the needs of an automated optical inspection system where the surface under test must be in the order of 30 mm-40 mm from the imaging lens assembly in order to allow for the height of components placed on the surface.

Currently, line scan systems include a camera lens that images the work surface of a printed circuit board onto a linear sensor array. The work surface is typically 300 mm in width, which is significantly larger than the camera lens diameter. Thus, light from the work piece edge strikes the camera lens at angles as large as thirty degrees. Such large angles of incidence give rise to parallax, which causes features near the edge of the work surface to appear distorted in the image plane. Also, features can protrude as high as 10 mm from the surface. Such protrusions obscure other small features present on the work surface from being detected by the linear sensor array.

### SUMMARY OF THE INVENTION

In accordance with the invention, the longitudinal distance between the object plane and image plane is reduced as a result of the use of just one lens set, thereby reducing sensitivity to lateral fabrication errors.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram of a device for imaging an object plane into a linear sensor array using a single lens array assembly according to an embodiment of the present invention;

FIG. 2 is a schematic diagram of individual baffles of the single lens array shown in FIG. 1;

FIG. 3 shows a lens set configuration for use in the single lens array shown in FIG. 1;

FIG. 4 is a schematic diagram illustrating the variations afforded to the design of the baffles of the single lens array shown in FIG. 1; and

FIG. 5 shows a diagram of a header assembly according to an embodiment of the present invention.

### DETAILED DESCRIPTION OF THE EMBODIMENTS

Reference will now be made in detail to the present embodiments in accordance with the invention, examples of which are illustrated in the accompanying drawings, wherein like reference numerals refer to the like elements throughout. The embodiments are described below in order to explain the present invention by referring to the figures.

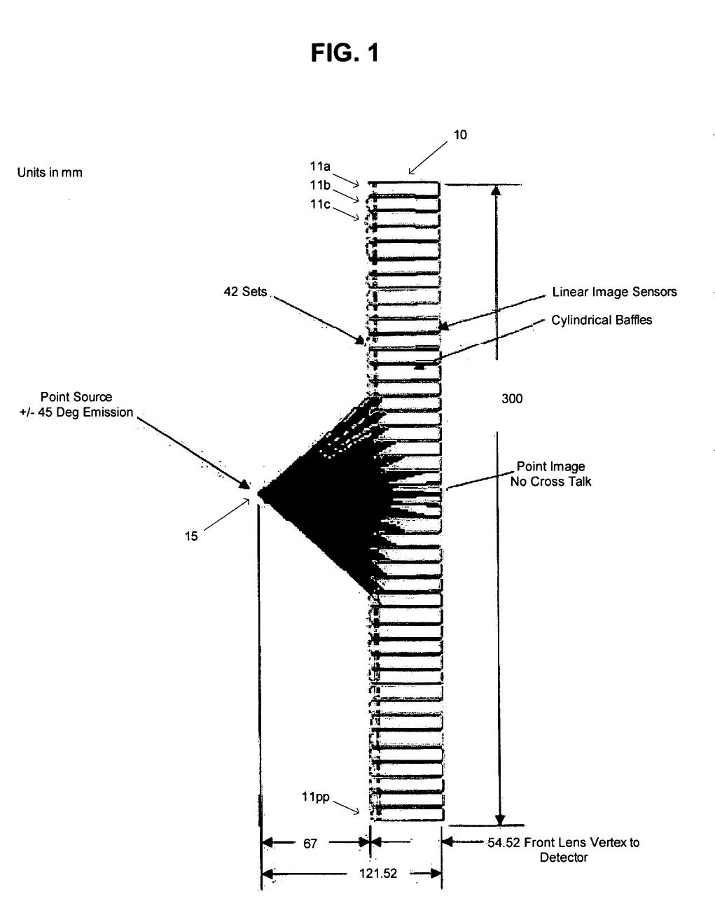

FIG. 1 is a schematic diagram of a device for imaging an object plane into a linear sensor array using a single lens array assembly 10. Referring to FIG. 1, the apparatus includes a plurality of tube-like baffles 11a through 11pp each housing an appropriately designed lens and image sensor. The lenses are arranged to provide inverted and de-magnified imaging of an object 15 to a plane of image segments.

The object distance can be altered according to the needs of the particular application. Automatic optical inspection systems used to line scan printed circuit boards need at least 40 mm between the object surface and the imaging lens assembly in order to allow for the height of components on the object surface. In the present embodiment, the object distance is approximately 67 mm so as to ensure adequate imaging with the optics used.

The number of tube-like baffles and thus the number of lens assemblies and image sensors making up the single lens array depend on the size of the work surface being scanned. Automatic optical inspection systems used to line scan printed circuit boards typically span a width of 300 mm in order to image the entire circuit board. In the present embodiment, 42 tube-like baffles 11a through 11pp are used to span a width of 300 mm.

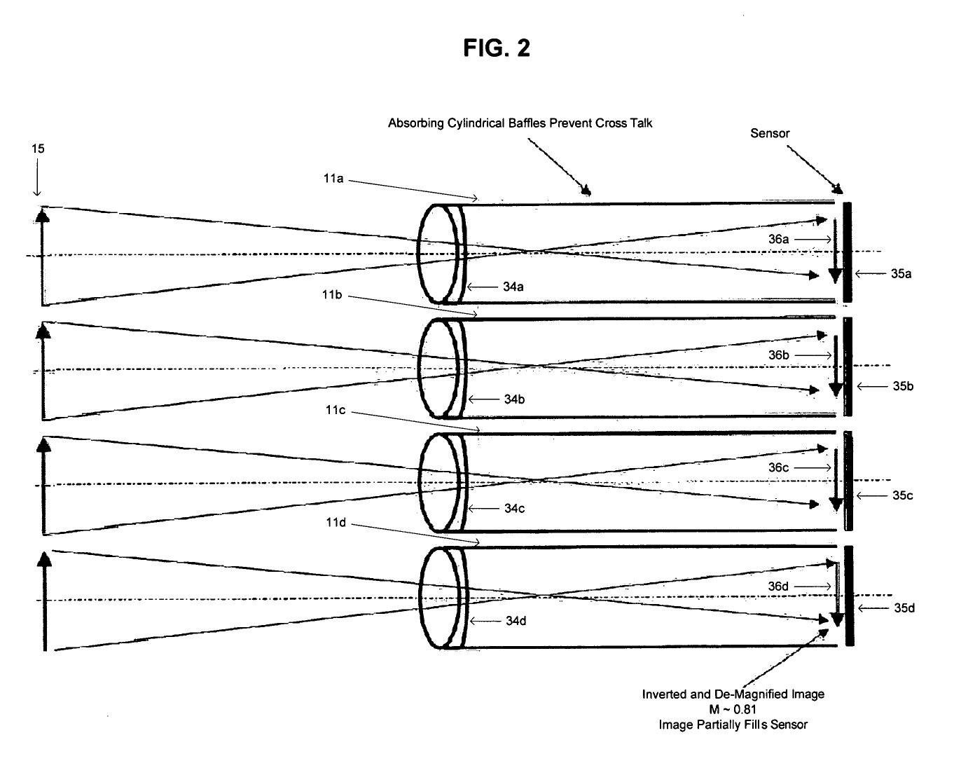

FIG. 2 is a schematic diagram of individual baffles 11a through 11d of the single lens array shown in FIG. 1. Each individual baffle of the lens array 10 is a hollowed out tube. Disposed at the end of each baffle 11a through 11d closest to the object plane is a respective doublet lens 34a through 34d and disposed at the other end is a respective linear image sensor 35a through 35d. The light reflected from the object plane is imaged by each doublet lens 34a through 34d onto the respective linear image sensor 35a through 35d. Each doublet and sensor pair is contained within the tube-like baffle to prevent optical cross talk.

Each image segment 36a through 36d is inverted and de-magnified. The demagnification allows each image segment to be contained within a baffle without obscuration. Also, each image is undersized relative to the linear image sensor 35a through 35d and, accordingly, the lateral image position can vary somewhat and still be entirely captured by the linear image sensor 35a through 35d. Each lens set design can be optimized and additional lenses added for different magnification values. In the present embodiment, there is one doublet lens set 34a through 34d in each baffle.

The baffles 11a through 11d further isolate each lens set 34a through 34d from adjacent lenses and reduce the field of view of each lens, thereby reducing off axis optical aberrations and thus enabling good imaging performance. Each lens set design can be optimized and additional lenses added for more aberration reduction or different fields of views. In the present embodiment, the field of view of each lens set 34a through 34d is approximately 5 degrees.

The length of the baffles 11a through 11d can also be altered to suit the requirements of the focal length and optimize imaging. In the present embodiment, the length of each baffle 11a through 11d is 54.52 mm.

The distance between each baffle 11a through 11d can also be altered according to the pixel spacing of the image sensors in order to optimize imaging. In the present embodiment, there is 1 mm spacing between individual baffle 11a through 11d.

The baffles 11a through 11d can be manufactured from any absorbing material with structural strength, such as anodized aluminum.

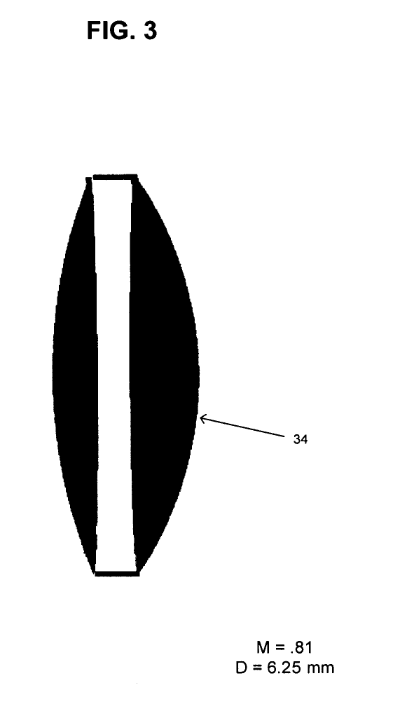

FIG. 3 shows a lens set 34 configuration for use in the single lens array shown in FIG. 1. In this embodiment, an achromatic, doublet lens assembly is shown comprising two convex lenses with magnification and diameter equal to 0.81 and 6.25 mm respectively.

As described earlier, each lens set 34 is disposed at the end of its respective baffle closest to the object plane. The lens set 34 is so arranged to provide inverted and de-magnified imaging. It may be held in place by use of an adhesive or other suitable means. Additional lenses may be added to each lens set as appropriate, or to reduce aberration.

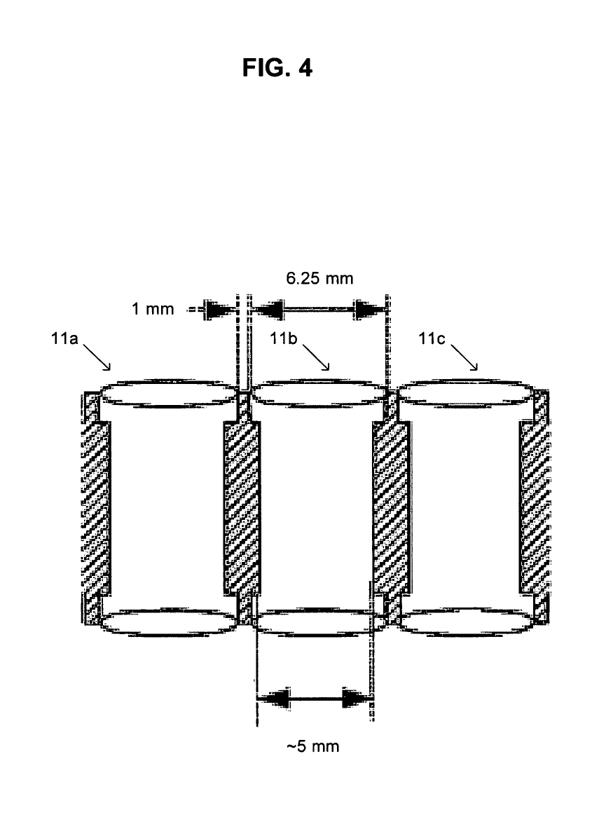

FIG. 4 is a schematic diagram illustrating the variations afforded to the design of the baffles of the single lens array shown in FIG. 1. The baffles 11a through 11c may have a constant diameter from end to end; however, this may be altered in order to ease the manufacturing tolerances of each baffle. As seen in FIG. 4, each baffle 11a through 11c can have an inner diameter of 6.25 mm near the edges and can be machined such that the inner diameter decreases towards the center of the baffle. For example, the inner diameter at the middle of each baffle 11a through 11c of FIG. 4 is 5 mm. Alternatively, the inner diameter of the baffles 11a through 11c can vary from one end to the other provided the inner diameter at each end is sufficient to receive the lens set and image sensor.

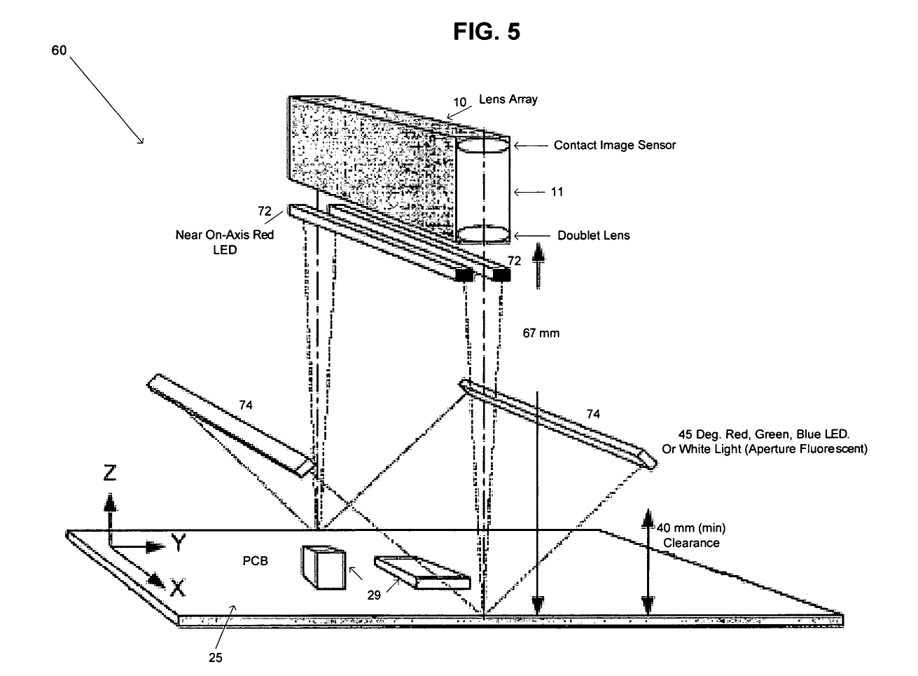

FIG. 5 shows a diagram of a header assembly for imaging an object plane 25 through a single lens array into linear image sensors 35 according to an embodiment in accordance with the invention. Referring to FIG. 5, the header assembly 60 in accordance with the invention comprises a single lens array 10 and light sources 72 and 74. The header assembly 60 is disposed over an object plane 25 which in the case of printed circuit boards has a variety of components 29 disposed on its surface. Each of these components may have a varying height above the surface thus requiring that the header assembly 60 have a clear working distance of at least 40 mm. In this instance, the object distance is 67 mm.

The lighting of the header assembly comprises a near on-axis LED array 72 disposed under the baffle array assembly 10 and a further LED array 74 disposed at approximately 45 degrees, in the present embodiment, with respect to the object plane. This results in both on-axis illumination as well as diffuse illumination resulting in better feature detection of components on the object surface.

The image segments formed by the single lens array are stitched together by using a featureless substrate that reflects light with uniform intensity into the optical imaging system. Dark pixels in the image sensors are electronically monitored and referenced so as to be eliminated in future images allowing the remaining pixels to be stitched together.

According to the present invention as described above, by using just one lens set, the longitudinal distance between the object plane and image plane is reduced, and, therefore, sensitivity to lateral fabrication errors is reduced. By isolating each lens set, off axis aberrations are reduced thus enabling good imaging performance. By de-magnifying a received image, obscuration is reduced.

Although a few embodiments in accordance with the invention have been shown and described, it would be appreciated by those skilled in the art that changes may be made in this embodiment without departing from the principles and spirit of the invention, the scope of which is defined in the claims and their equivalents.

What is claimed is:

1. A single lens array optical imaging system to produce an image on an image plane of an object plane, the system comprising:
a plurality of baffles having a first side and the image plane; and
a plurality of lens sets, each lens set disposed at the first side focusing a corresponding image segment of the object plane onto the image plane of the baffles.

2. The system as claimed in claim 1, wherein each lens set de-magnifies a received image thus reducing obscuration.

3. The system as claimed in claim 1, wherein the baffles are arranged in a plane.

4. The system as claimed in claim 3 comprising 42 baffles arranged in a plane.

5. The system as claimed in claim 1, wherein the baffles are tube-like.

6. The system as claimed in claim 1, wherein the baffles have a space there between.

7. The system as claimed in claim 1, wherein the first side is located inside an end closest to the object plane of a respective one of the baffles.

8. The system as claimed in claim 1, wherein the lens sets provide inverted imaging.

9. The system as claimed in claim 1, wherein each lens set comprises one doublet lens.

10. The system as claimed in claim 1, wherein each lens set comprises one or more lenses, as appropriate for imaging optimization.

11. The system as claimed in claim 1, wherein each baffle comprises a linear image sensor disposed at the image plane.

12. The system as claimed in claim 11, wherein the image plane is located inside an end farthest from the object plane of a respective one of the baffles.

13. A header assembly over an object plane comprising:
a single lens array optical imaging system to produce an image on an image plane of an object plane, the system comprising:
a plurality of baffles having a first side and the image plane; and
a plurality of lens sets, each lens set disposed at the first side focusing a corresponding image segment of the object plane onto the image plane of the baffles; and
a light source, wherein the light source illuminates the object plane for imaging.

14. The header assembly as claimed in claim 13, wherein the light source comprises an LED array disposed to provide near on-axis illumination on an object plane.

15. The header assembly as claimed in claim 14, wherein the light source further comprises a second LED array to provide diffuse illumination on the object plane.

16. The header assembly as claimed in claim 13, wherein the lens set comprises one or more lenses, as appropriate for imaging optimization.

17. The header assembly as claimed in claim 13, wherein each lens set comprises one or more lenses, as appropriate for imaging optimization.

18. The header assembly as claimed in claim 13, wherein each lens set de-magnifies a received image thus reducing obscuration.

19. The header assembly as claimed in claim 13, wherein each baffle comprises a linear image sensor disposed at the image plane.

20. A method of stitching together image segments of an optical imaging system, the method comprising:
using a featureless substrate that reflects light with uniform intensity into an array of single lens sets that refract the light into a corresponding array of image sensors;
electronically monitoring dark pixels in the array of image sensors and referencing these dark pixels; and
eliminating these referenced dark pixels and stitching together remaining pixels of future images.
